(19) United States
(12) Patent Application Publication
(10) Pub. No.: US 2006/0086039 A1
(43) Pub. Date: Apr. 27, 2006

(54) Device for dispensing a substance to insects or mites

(75) Inventors: Nimrod Israely, D.N. Modi'in (IL); Itay Oren, D.N. Modi'in (IL)

Correspondence Address: BROWDY AND NEIMARK, P.L.L.C.;624 NINTH STREET, NW, SUITE 300, WASHINGTON, DC, 20001-5303, US

(73) Assignee: Nimrod Israely, D.N. Modi'in (IL)

(21) Appl. No.: 11/253,818

(22) Filed: Oct. 20, 2005

(30) Foreign Application Priority Data
Oct. 20, 2004 (IL) 164728

(51) Int. Cl. A01M 1/20

(52) U.S. Cl. 43/132.1; 43/131

(57) ABSTRACT

The present invention discloses a device for dispensing a substance for insects or mites, the device comprising a container holding a liquid formulation comprising said substance and a substrate, the container having a dispensing nozzle that can discharge the formulation in a controlled manner onto said substrate. The substrate may be porous or non porous and the container may be in physical contact with the substrate or suspended above.

### FIELD OF THE INVENTION

This invention relates to a device for dispensing substances to insects or mites.

### BACKGROUND OF THE INVENTION

Despite the progress in new compounds and compositions aimed for controlling flying insects, the mode of delivering the active material has remained much the same over time. The prevailing method for controlling the insecticides, despite its drawback, is by spraying the area with the most effective formulation. Part of the hazardous nature of pesticides in general emerges from this ineffective route for their application. Another problem associated with their use stems from the fact that the entire vegetation, i.e. the fruit, vegetable, branches and leaves, and its vicinity (ground, and air) is coated with the active insecticide, as well as the draft.

Traps among other means (repellents, electric killing etc.) are an alternative approach to spraying the entire area to be protected in order to control flying insects. The insects are attracted to the traps by attractants which may be chemical, food or sex attractants or by physical means such as color and shape. Color may also be an attractant as disclosed in IL 103,629 where a yellow panel and a red sphere were found to be effective for attracting flies. After being attracted, the flies are eliminated either by physically being trapped within the trap, or by initially covering the trap's panel with glue, thus the attracted flies are stuck after their approach and die due to lack of food. Apart from a rather limited efficiency, traps are associated with drawbacks. In the case of physically trapping the insects, the insects are indeed attracted to the near vicinity of the trap, however, very frequently do not find their way into the trap. If the entrance is made easy enough for the approaching insects, then their way out is also facilitated. In case the insects are stuck in the glue, the efficiency is greatly reduced due to the fact that the glue is very non-selective. In the latter case, dust, leaves and other non-target insects adhere to the trap in addition to the desired insects. Furthermore, the trap has a very limited range due to the fact that once it is covered with desired or non desired substance it is no longer useful.

Alternatively, the trap may be covered with a poisonous material and the insects are exterminated as a result of contact or consumption of an insecticide. U.S. Pat. No. 5,359,808 discloses such a trap consisting of a bag soaked prior to its use with insecticide where the approaching flying insects are exterminated upon contact with the bag. The attractants are immersed in water, the water serving as a source of humidity thereby being themselves an additional attractant. The use of such a trap is restricted to hot periods. Furthermore, the humidity has to be replenished in order to stay effective for long periods. IL 129634 (corresponding to U.S. Pat. No. 6,708,445) discloses yet another trap. The trap is a planer device having a pocket for storing a viscous composition poisonous to insects containing attractants. Upon contact of the trap with humidity, the outer part of the viscous composition is dissolved and spreads on the trap, attracting insects and killing them upon digestion of the poisonous composition. However, humidity controlled release of the viscous composition is not uniform and the variance in the amount of available poisonous composition on the entire trap leads to variance in its efficacy.

### SUMMARY OF THE INVENTION

The present invention is based on a new design of a device for dispensing substances to invertebrates, particularly insects or mites. The new device enables in particular dispensing of such substances in a controlled manner. The substances may be insecticides for combating pest insects, or may be nutritional and/or therapeutic, for supporting growth and well being of farmed insects, such as in particular in the case of honey bees. The controlled dispensing according to the invention is independent of environmental effects.

The invention provides a device for dispensing a substance for invertebrates, the device comprising a container holding a liquid formulation comprising said substance and a liquid-retaining substrate, the container having a dispensing opening that can discharge the formulation in a controlled manner onto said substrate.

The invention is thus directed to a device for dispensing a liquid formulation that comprises the substance in a controlled manner, from a container onto a substrate. The substrate receives and accommodates the discharged formulation and thus the insect can come into contact therewith. Where the substance is an insecticide, such contact will lead to eventual extermination of the insect (which may be immediate or delayed). In such a case, the formulation will often also comprise a substance to lure the insects, which may be a nutritional substance such as sugar or a protein hydrolisate, a para-pheromone, or a pheromone. The substance may also be a nutritional substance intended for feeding farmed insects, such a s honey bees, for example at times when their natural food is scarce. Another example of a substance is an antibiotic for controlling or combating infections of farmed insects. Another example of a substance is for feeding natural native beneficial insects (such as ladybugs or Anisochryza (Chrysoperla) carnea) in times of lack of feeding sources, and by doing so supporting the existence of the local population. Another example of a substance is for attracting-feeding-and-controlling ant population in the field.

By one embodiment of the invention, the opening is not in physical contact with the substrate and the discharge of the formulation is by gravitation from the opening onto the substrate, e.g. by dripping out of the opening. According to another embodiment, the container is fitted such so that the opening is in physical contact with the substrate.

By one embodiment, said substrate comprises a porous material. The porous material may be any material enabling the diffusion of the discharged liquid such as a synthetic e.g. polymeric or non synthetic fabric e.g. cloth, textile. Such a substrate becomes substantially soaked with the formulation and is maintained so by the continuing controlled release of the formulation from the nozzle. In accordance with another said substrate comprises a basin, e.g. in the form of a shallow dish. The former embodiment is particularly suitable for the case where said opening is in direct contact with said substrate; the latter one, for the case where the discharge of said formulation is gravitational.

By one embodiment, the device is adapted for hanging to trees or bushes or onto support structures and is equipped with appropriate hanging means. In accordance with another embodiment, the device comprises a support structure for attaching to vegetation, for fitting onto the ground, etc. An example for such a support structure is one that includes a pole with a sharpened ending for inserting into the ground.

In accordance with an embodiment of the invention, the container is fitted at an upper part of the device. Typically, in accordance with this embodiment includes a pocket at an upper part thereof that houses said container. The pocket may be formed from flexible sheets, e.g. sheets of said porous material that are detached at some portions from the surface of the device to define said pockets.

By one embodiment, said substance is a pesticide. By another embodiment, said substance is a nutritional or a health additive (e.g. an antibiotic) for supporting farmed invertebrates, e.g. honey bees. The formulation may also comprise substances that have nutritional values, such as sugar, protein hydrolisate, or a pheromone.

In order to improve the luring efficiency of the device, it may be colored with colors having an insect attractant property, for example yellow in the case of fruit flies. Possibly, also, the device may be colored with a pattern of two or more colors, for example in a combination of yellow and red.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is an elevation view of a preferred embodiment of a device according to the present invention where the container is situated within a pocket being part of the device.

FIG. 2 is an elevation view of another preferred embodiment of a device according to the present invention where the container is fastened to the upper part of the device.

FIG. 3 is an elevation view of another preferred embodiment of a device according to the present invention where the device further comprises a two-colored pattern for attracting flying insects.

FIG. 4 is an elevation view of another preferred embodiment of a device according to the present invention where the container is situated above a porous material.

FIG. 5 is an elevation view of another preferred embodiment of a device according to the present invention where the container is situated above a non-porous material.

### DETAILED DESCRIPTION OF THE INVENTION

The invention shall now be illustrated with reference to some non limiting specific embodiments which are depicted in the annexed drawings. As will be appreciated, a large number of modifications of the depicted devices may be made, within the scope of the invention as defined herein. For example, the illustrated geometric shapes are but an example and the device may have various different other shapes.

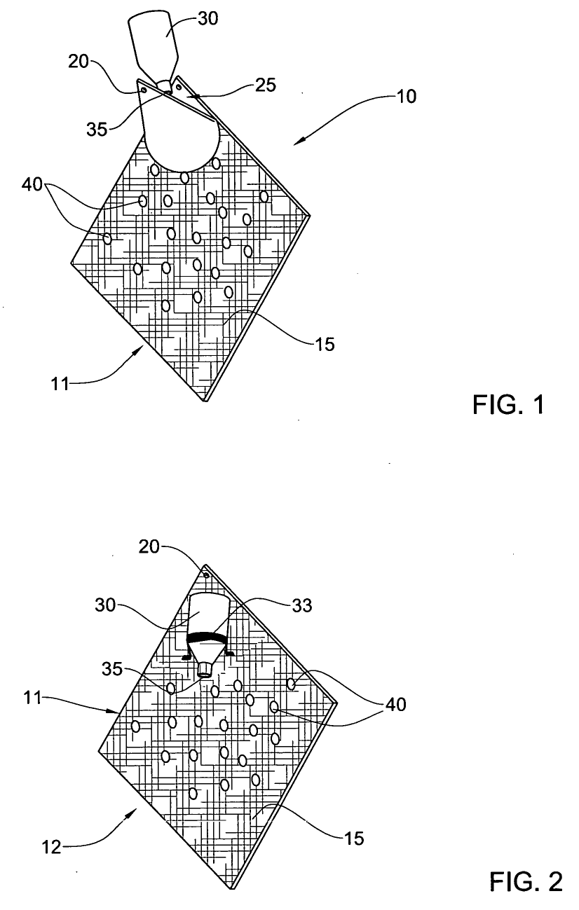

Turning first to FIG. 1, there is shown a device 10 for dispensing a substance for invertebrates, such as insects or mites. As already explained above, depending on the intended use, the substance may be a pesticide, a substance with nutritional values such as sugar or a protein hydrolizate, a pheromone, an antibiotic, etc.

The device includes a matrix 11 which in this specific embodiment has a rhomboid shape. However, as will be appreciated the matrix may have a variety of different polygonal shapes or may also be round or oval. Regarding dimensions, typically each of the sides of the matrix 11 are in the range of 20-40 cm. Matrix 11 is made of substantially porous material 15. The upper portion of the device has a pocket 25 which is appropriately shaped so as to accommodate a container 30. At the upper part of pocket 25 are two holes 20 for hanging the device.

Container 30 holds a liquid substance to be discharged, and has an opening 35 with a nozzle (not shown). Prior to inserting container 30 into pocket 25, the nozzle is open to permit control discharge of the liquid formulation within the container which includes the substance. Through capillary and/or gravitational forces the liquid formulation with said substance scatters throughout matrix 11, as represented by a plurality of droplets 40 in FIG. 1.

In the following description of the additional embodiments, like reference numerals will be used to indicate like components. The reader may need to occasionally refer to the description of FIG. 1 for a full explanation of such components.

FIG. 2 shows a device 12 of a different embodiment in which container 30 is held by a holder 33 at the upper portion of the device. Holder 33 may, according to some embodiments, be oriented so that the bottle will be slightly slanted so that the opening 35 will face a portion of matrix 11. In operation, liquid formulation which is contained in container 30 will gradually drip thus soaking the porous material 15 with the formulation and leading to a scattering of substance 40 throughout the matrix.

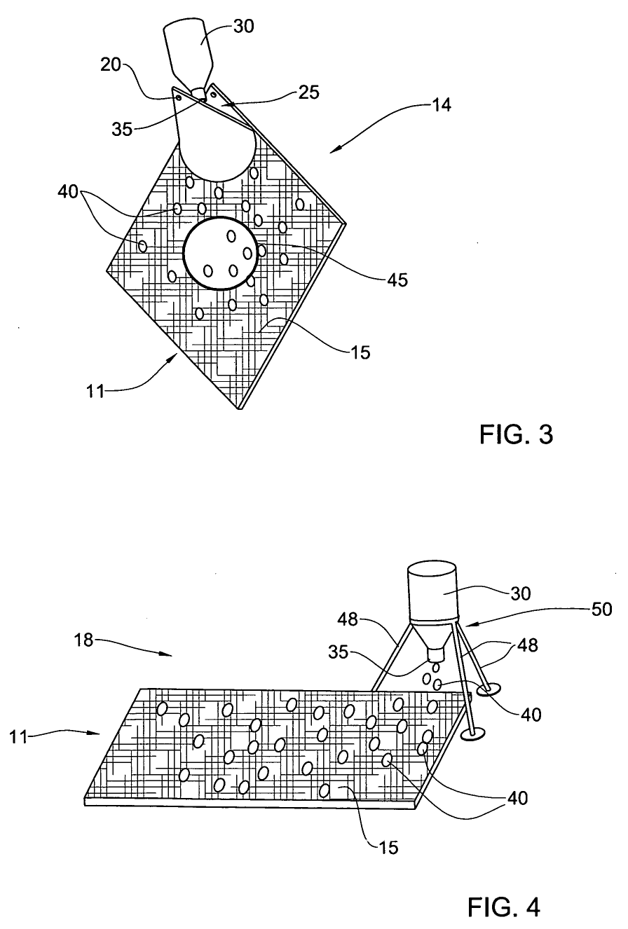

FIG. 3 shows another embodiment 14 which is very similar to that of FIG. 1, the difference being that rather than having a single colored matrix, the matrix has a colored pattern consisting, in this embodiment, from a central portion 45 of one color and the periphery of another color. Exemplary colors are red for the central portion 45 and yellow for the remaining portion of the device. Such a colored pattern is particularly suitable for trapping fruit flies.

FIG. 4 shows another embodiment in which the device 18 has two distinct components: the matrix 11 and a container unit 50. Container unit 50 consists of container 30 and a support structure 48. The support structure is placed such that opening 35 will drip-dash discharge its contents gradually on to a portion of the matrix thus causing the matrix to be gradually soaked with the liquid formulation thus scattering the substance throughout the matrix 11. The matrix 11 according to this embodiment may be positioned horizontally, e.g. placed on the ground, may be elevated, may be positioned in a slanted position, etc.

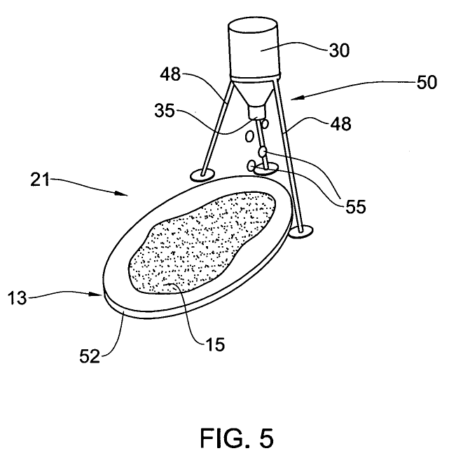

Reference is now being made to FIG. 5 showing a device 21, which consists of two components, a container component 50 and a substrate 13 which has a slightly elevated rim 52 so as to be able to hold a liquid. Container component 50 is situated so that liquid formulation drops 55 which are discharged out of opening 35 will accumulate there.

As mentioned the present invention is directed to a device for controlled dispensing a substance for insects or mites. The device comprises a container and a substrate. The substance to be discharged is a liquid formulation stored in a container equipped with an opening that has a suitable mechanism which enables the discharging of a predetermined amount of substance at a predetermined rate onto the substrate. Such mechanisms are generally known per se. The substrate may be a substantially porous material or a non-porous material serving as a receptacle for the discharged material. In case the substrate is a substantially porous material, the discharged substance spreads to a large area of the substantially porous material or even to the entire area by capillary and/or gravity forces. Parameters governing the amount of substance discharged from the container (other than the suitable mechanism) and which is adsorbed by the substantially porous material are the viscosity of the discharged substance and the density of the porosity of the substrate. The mechanism at the nozzle governing the rate of discharging of the liquid material may be any mechanical, electrical, electromechanical or any other mechanism enabling the discharge of a predetermined volume of the stored liquid in a predetermined time. The diameter of the hole in the container and the existence or absence of an additional opening for allowing entry of air into the container also contribute to the rate of discharging and should also be taken into account. In case the discharged substance falls on a porous material, any substance discharged from the container spreads on the surface of the porous device by capillary and/or gravity forces resulting in that the surface of the device is filled with the discharged substance. Any amount of discharged substance beyond the capacity of the porous material simply drips from the porous material. The substantially porous material may be made of any synthetic or natural material as long as it is a porous material that allows the propagation and spreading of the released substance from the container. Non limiting examples of such porous material are synthetic and non synthetic fabric, e.g. cotton, paper, fibrous material or porous polymeric substance.

The device may be a one-unit device, such as that illustrated in FIG. 1 and FIG. 2 where the container carrying the liquid substance to be discharged and the substantially porous material are integrated together. In such a one-unit device, the container may be inserted into a pocket situated at the upper part, as in FIG. 1 or may be fastened to the upper part by any fastening means, as in FIG. 2. Non limiting examples of fastening means are a hook, band, hook and pile (Velcro®) mechanism or pins.

Alternatively, the device may be a two-unit device, where the container carrying the substance to be discharged onto the substrate is part of a separate unit from the substrate, i.e. there is no physical contact between the nozzle and the substrate. Such a two-unit device is shown in FIGS. 4 and 5. In such a device, the substrate which may be a porous or a non-porous material, may be placed on the surface of the desired location (plantation or any other appropriate location) and the container is suspended above at a distance from the substrate by any possible manner. The container may be suspended from a pole, a tree, wall, ceiling etc. Alternatively, it may be supported on a support structure as depicted in FIGS. 4 and 5.

In order to attract insects or mites to approach the device, the device may be colored in a specific color known to attract such insects or mites. It may further possess an additional colored section within the substrate's area such that the contrast in colors may aid in attraction. In the latter case of contrast, the additional colored section may be of a specific shape, e.g. square, rectangular or rounded. It should be mentioned that a yellow/red combination is known in the art to attract flying insects, in particular fruit flies. The substance to be discharged from the container generally should contain an active component such as a poisonous composition or a nutritional/therapeutical composition together with a chemically attracting substance which aids in bringing the insects or vertebrates to the vicinity of the device.

The device may be used for any operation involving feeding insects or mites with the discharged substances. In one aspect the device of the present invention may be used for controlling insects or mites, in particular, flying insects, by poisoning them. The discharged substance in such a case comprises at least one insecticide where upon ingestion or contact, the pest is exterminated. Alternatively, the device may be used as a feeding station for desirous insects or mites which have a beneficial effect on the plantation such as bees, lady bugs, predatory mites and wasps. In such a case the substance to be discharged from the container has nutritional value or therapeutic value for the insects or vertebrates.

The benefit of using a container for storing the substance to be released is that the composition is protected from environmental effects as long as it is stored within the container. Sensitive components are thus saved from oxidation, degradation, evaporation, or reaction with air. Another benefit of the use of a container is the versatility of the device and the possibility of adjusting the rate of release to the different seasons and different ripening in the plantation attracting different population of insects. It should be understood that the container may be replaced once all of its contents were released or it may be refilled. The device may be used for consequent uses and even for different uses depending on the nature of the contents of the substance in the container. Changing the function of the device from an insect controlling device to a feeding and/or therapeutic station merely requires rinsing thoroughly the substrate and the container in order to eliminate all residues of prior material. Alternatively, only the substrate is thoroughly rinsed and the container is replaced.

1. A device for dispensing a substance for insects or mites, the device comprising a container holding a liquid formulation comprising said substance and a substrate, the container having a dispensing nozzle that can discharge the formulation in a controlled manner onto said substrate.

2. A device according to claim 1 wherein the nozzle is not in physical contact with the substrate and the discharge of said formulation onto the substrate is gravitational.

3. A device according to claim 1, wherein the nozzle is in physical contact with said substrate and the discharge of the formulation is directly onto the substrate.

4. A device according to claim 1, equipped with hanging means.

5. A device according to claim 1, comprising a support structure.

6. A device according to claim 3, comprising a pocket at the upper part thereof housing the container.

7. A device according to claim 3, wherein said container is fitted at the upper part of said device.

8. A device according to claim 1, wherein said substrate is a made of a substantially porous material.

9. A device according to claim 1, wherein said substrate is made of a non porous material.

10. A device according to claim 1, wherein said substance is a pesticide.

11. A device according to claim 1, wherein said substance is an insect nutritional or therapeutic substance.

12. A device according to claim 1, being colored with an insect attracting color.

13. A device according to claim 12, being colored with a color pattern such that at least one portion thereof has a different color than the rest of the device.
